(19) United States
(12) Patent Application Publication
(10) Pub. No.: US 2014/0150589 A1
(43) Pub. Date: Jun. 5, 2014

(54) SYSTEM FOR LUBRICATING INPUT SHAFT SPLINE OF FINAL DRIVE TRANSMISSION

(71) Applicant: DEERE & COMPANY, Moline, IL (US)

(72) Inventors: Donald O. Johannsen, Dubuque, IA (US); Denis J. Roling, Dubuque, IA (US)

(73) Assignee: One John Deere Place, Moline, IL (US)

(21) Appl. No.: 13/705,305

(22) Filed: Dec. 5, 2012

(51) Int. Cl. F16H 57/04

(52) U.S. Cl. CPC F16H 57/0457
USPC 74/467

(57) ABSTRACT

The splines of a connection between a connecting collar and transmission input shaft includes a main lubrication oil passage extending axially through an input gear in alignment with a blind bore provided in a wall of a compartment containing the input gear and a second gear meshed with the input gear and partially immersed in an oil reservoir defined by a lower region of the compartment. An oil capture recess is located in a wall region above the blind bore and adjacent a roller bearing supporting one side of the input gear. A bypass lubrication oil passage connects the capture recess to the blind bore. An oil transfer tube is carried by a sheet metal cup mounted in a circular recess joining the blind bore and has opposite ends positioned in the main lubrication oil passage and the blind bore. The bypass passage bypasses the roller bearing.

### FIELD OF THE INVENTION

The present invention relates to providing lubrication for components located within a final drive transmission housing.

### BACKGROUND OF THE INVENTION

The final drive input shaft for final drive transmissions is often coupled to the drive train within the housing by a drive coupling collar having internal splines which engage a splined end of the input shaft. Current construction class vehicles equipped with such an input shaft coupling are found to experience spline fretting leading to the eventual need for replacement of the shaft. This results in both high repair cost and downtime for the customer.

In order to extend the expected wear life of the transmission, a way of extending the life of the input shaft coupling splines is needed.

### SUMMARY OF THE INVENTION

According to the present invention, there is provided a novel lubrication arrangement for lubricating components within a final drive housing, and more specifically, there is provided an improved arrangement for adequately lubricating the final drive input shaft region so as to eliminate fretting of the coupling splines.

An object of the invention is to provide a design by which lubrication oil is elevated from a lower portion of the final drive housing and deposited in the region of the spline coupling for the input shaft. This object is achieved by piecing an input gear set comprised of an input gear meshed with a larger bull gear within a relatively small compartment formed in the final drive housing, with lubrication oil in the compartment having a level approximately at the center of the larger gear. A bearing cup at one end of the input gear hub is in fluid communication with a fluid passage extending axially through the gear hub to a location adjacent the splines in the coupling collar, with the meshed gears acting to spray oil to the surfaces of the compartment located above the input gear from where it runs downward through the bearing and bearing cup to the fluid passage and then to the coupling collar splines and mating input splines of the input shaft.

### BRIEF DESCRIPTION OF THE DRAWINGS

FIG. 1 is a longitudinal sectional view of a final drive transmission incorporating a lubrication arrangement constructed in accordance with the present invention.

FIG. 2 is a view showing an enlarged portion of the sectional view of the final drive transmission shown in FIG. 1 including the input gear but indexed angularly about the axis of the input gear so as to show fluid passages, not visible in FIG. 1, of the system for providing lubrication oil to the input shaft spline connection of the final drive transmission.

### DESCRIPTION OF THE PREFERRED EMBODIMENT

Referring now to the drawing, there is shown a longitudinal sectional view of a final drive 10 forming one of a pair of final drives of an off-road machine (not shown). The final drive 10 includes a split gear housing including a fixed housing section 12 having a rightward portion defined by a spindle 14, and a rotatable housing section defined by a wheel hub 16.

As viewed in the drawing, an upper left region of the fixed housing section 12 defines an input portion including a brake housing 18 containing a stack of brake discs 20, some of which are mounted to the housing 18 for shifting axially and are interleaved with other discs coupled to an exterior of an enlarged right end region of an input collar 22 having an internal left end region formed with splines 24 adapted for engaging complementary splines provided at a right end of an input shaft (not shown). The input collar 12 has an internal right end region provided with splines coupled to an externally splined left end region of a leftward shaft-like extension 26 forming a left end continuation of a hub 28 of an input gear 30.

The input gear 30 is meshed with a larger bull gear 32 having a hub 33 received on, and fixed for effecting rotation of, a leftward shaft-like extension 34 of a sun gear 36 meshed for driving planet gears 38 carried by a planet carrier 40, the planet gears 38 also being meshed with teeth of a ring gear 42 surrounding the carrier 40.

The input gear 30 and bull gear 32 are located in a small compartment 42, with right and left end regions of the input gear hub 28 respectively carrying inner races of right and left roller thrust bearings 44 and 46 having outer races respectively received in recess provided in upper right and left side wall regions of the compartment 42. Similarly, opposite end regions of the bull gear hub 33 respectively carry inner races of right and left roller thrust bearings in lower right and left wall regions of the compartment 42.

The sun gear 36 has a stub shaft formed integrally with its right side and supported for rotation by a pilot bearing 52 located within an axial recess provided in a left end of an output shaft 54 disposed in axial alignment with the sun gear 36 and extending centrally through the spindle 14 and into the wheel hub 16. The planet carrier 40 has an annular left side portion defining an axial flange carrying an inner race of a left roller thrust bearing having an outer race carried within an annular recess provided in the lower region of the right wall of the compartment 42. The right side of the planet carrier 40 is provided with an annular hub 58 received on and coupled for transmitting rotation of the carrier to, the output shaft 54. An exterior surface of the hub 58 carries an inner race of a right roller thrust bearing 60 having an outer race received in an annular stepped recess provided in a right face of the spindle 14.

A right end region of the output shaft 54 has a sun gear 62 received thereon for being driven by the output shaft, the sun gear 62 being meshed with planet gears 64 being mounted to a carrier 66 defined by a right end plate of the wheel hub 16. The planet gears 64 are also meshed for traveling about internal teeth of a ring gear 68 having a hub 70 received on and fixed to an exterior right end region of the spindle 14.

The wheel hub 16 includes a thick left side region provided with a central opening 72 having right and left regions into which outer races of identical right and left roller thrust bearings 74 and 76 are respectively pressed, the inner races of the bearings 74 and 76 being respectively pressed onto that portion of the ring gear hub 70 which is mounted on the right end region of the spindle 14 and onto an annular shoulder of the spindle 14. Thus, the bearings 74 and 76 serve to mount the wheel hub 16 for rotation about the longitudinal axis of the output shaft 54 noting that the hub 16 is driven in rotation by the output shaft 54 acting through the planetary gear set 60, 64 and 68 which causes rotation of the carrier 66 and hence the wheel hub 16 which includes the carrier.

The spindle 14 includes a left end region that extends radially outwardly just to the left of the left thrust bearing 76 and that includes an annular right surface disposed in confronting relationship to a left surface of the wheel hub 16. This in surface of the spindle 14 and left surface of the wheel hub 16 thus define an interface region that is located radially outward of the left thrust roller bearing 76 and provided for sealing this interface to prevent leakage of lubrication oil surrounding the bearing 76 and prevent debris from entering from outside the gear housing and contaminating the lubrication oil is a sealing arrangement comprising inner and outer face seal assemblies 78 and 80, respectively, which comprise right and left identical elements arranged as mirror images of each other.

As thus far described, the final drive transmission 10 is conventional. The present invention will now be described.

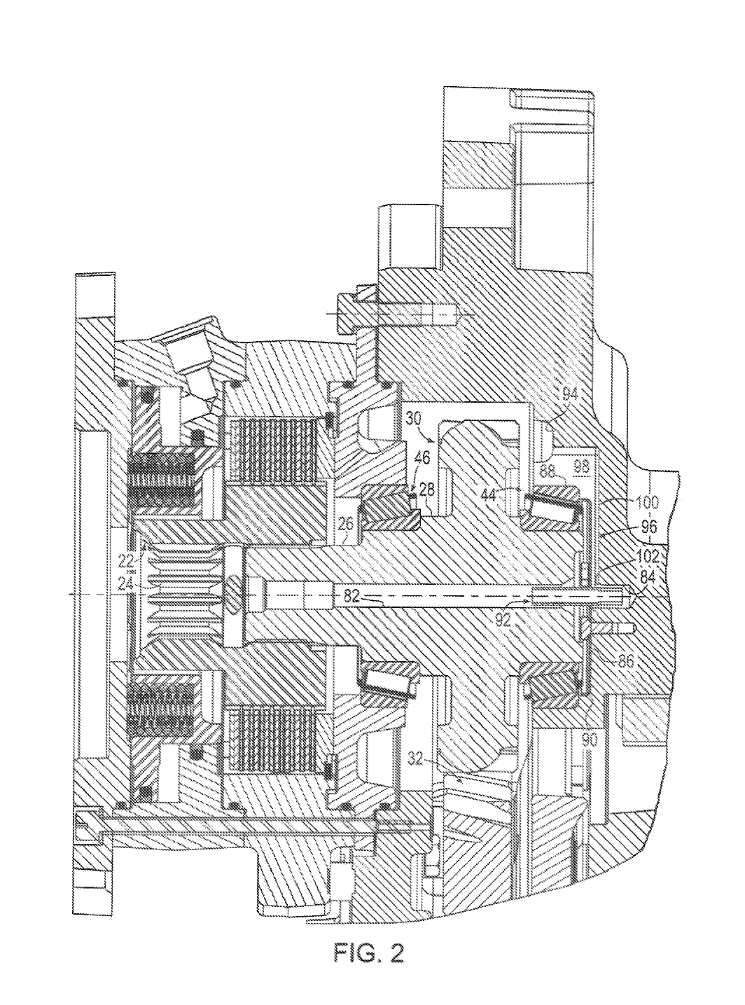

Referring now also to FIG. 2, it can be seen that the input gear 30 is provided with a through bore 82 extending axially through the hub 28 and being in alignment with a blind bore 84 provided in the housing 12 adjacent the right end of the input gear hub 28. A shallow leftward opening circular recess 86 is joined to, and extends radially outward from, a left end of the blind bore 84 to a location adjacent a bottom end of a cup or outer race 88 of the right thrust bearing 44 supporting the input gear 30. A sheet metal cup 90 is shaped complementary to, and is located in, the recess 86. A lubrication tube 92 is centered along the axis of rotation of the input gear 30, projects through, and is fixed to, the sheet metal cup 90 and has an inlet end located within the blind bore 84 and an outlet end located within the axial passage 82.

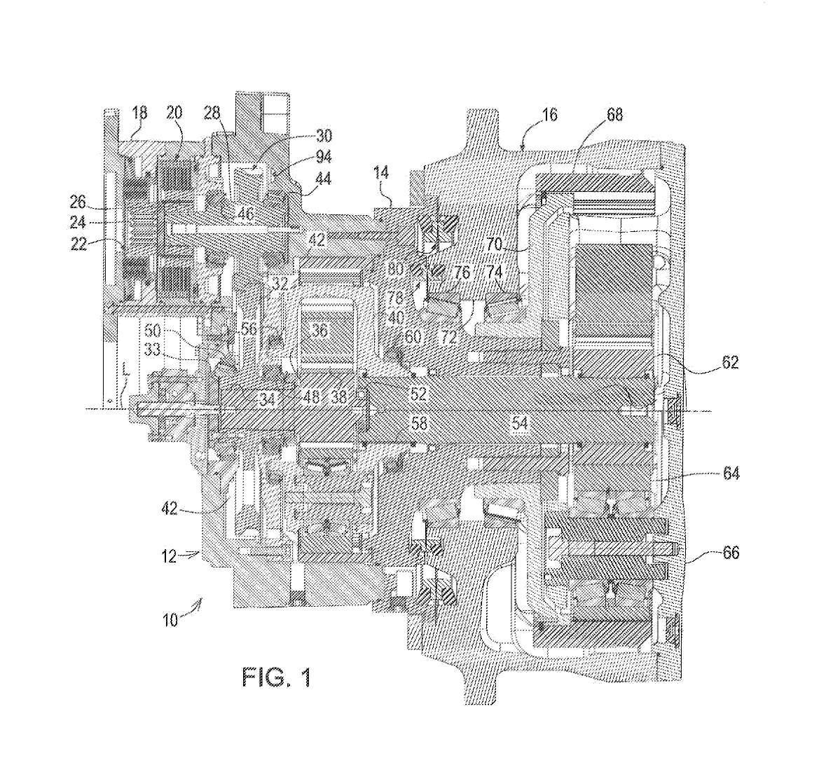

As can be seen in FIG. 1, the compartment 42 containing the meshed input gear 30 and bull gear 32 is normally filled with lubrication oil to a level L, which corresponds to the middle of the bull gear 32, and hence to the rotation axis of the output shaft 54. As the larger bull gear 32 rotates, it dips in the oil and sprays the oil to the outer surfaces of the compartment 42. Some of this sprayed oil and other of carried up by the bull gear 32 reaches the meshing input gear 30 which causes an additional spraying of oil upwardly onto the side wall surfaces of the compartment 42. An annular recess 94 is provided in a region of a right wall portion of the compartment 42 which is located beside a radially outer region of the input gear 30 and receives some of the sprayed oil as it gravitates down the right wall portion. A bottom region of the annular recess 94, which is located vertically above the axis of rotation of the input gear 30, is connected to the blind bore 84 by a vertical lubrication oil passage 96 providing a bypass passage for routing oil around the rollers of the bearing 44, and including a slot-like inlet section 98 extending from the bottom region of the annular recess 94 to top surfaces of the bearing cup 88 and sheet metal cup 90, an intermediate groove section 100 that extends vertically beside a bottom of the sheet metal cup 90, and a flared outlet end 102 joined to the blind bore 84. It is here noted that because the bearing cup 88 is not supported over the region exposed to the slot-like inlet section 98, the bearing cup 88 must be made of sufficient cross section to adequately support the bearing rollers over the unsupported area. In any event, the bypass passage 96 acts to route some of the lubrication oil captured by the recess 94 to the blind bore 84, from where the oil passes through the lubrication tube 92 and into the through bore 82, and from there to the internal splines 24 of the input shaft connection collar 22 and the splined end of the input shaft (not shown).

Having described the preferred embodiment, it will become apparent that various modifications can be made without departing from the scope of the invention as defined in the accompanying claims.

The invention claimed is:

1. In a final drive transmission including:
a sealed housing,
an input gear located in the housing,
first and second bearing assemblies mounting the input gear for rotation within the housing about a first rotation axis,
an input shaft connection collar located along said first rotation axis and having a first end coupled for driving said input gear and having an input splined coupling region at a second end adapted for being coupled to a complementary splined end region of an input shaft,
a driven gear located in the housing and being meshed with the input gear, and third and fourth bearing assemblies mounting the driven gear for rotation in the housing about a second rotation axis extending parallel to said first rotation axis, and
a system for providing lubrication oil to the input splined coupling region of said coupling collar, comprising:
walls interiorly of said housing defining a compartment containing said input and driven gears, defining a lubrication oil reservoir in a lower region below said input gear and through which said driven gear rotates, and having surfaces disposed adjacent opposite sides of said input and driven gears and including at least one lubrication oil collection recess located above said second bearing assembly;
said meshed input and driven gears acting, when rotating, to sling lubrication oil onto said surfaces of said compartment, with some of this lubrication oil being collected by said at least one recess; and
a first lubrication oil passage extending axially through said input gear and having an inlet end coupled in fluid communication with a bottom of said at least one lubrication oil collection recess and having outlet end located in fluid communication with said inlet coupling splines.

2. The final drive transmission, as defined in claim 1, wherein said input gear includes a hub, with said first bearing assembly including in inner race located at a first end region of said hub;
said system for providing lubrication includes an annular recess formed in said housing so as to be at least approximately centered on said first axis of rotation and extending radially from the first axis of rotation to an outer race of said first bearing assembly;
a shallow cup having a bottom located in annular recess;
a lubrication tube extending along said first axis of rotation and through, and being fixed to, said shallow cup, with an outlet end of said tube being located in said first lubrication fluid passage, and with an outlet end of said tube being located on an opposite side of said cup from said inlet end and being connected to said at leas one lubrication oil collection recess.

3. The final drive transmission, as defined in claim 2, wherein said annular recess includes a blind bore centered on said first axis of rotation and said inlet end of said lubrication tube being located in said blind.

4. A final drive transmission, comprising:
a housing having an input section;
an input connection collar being located in said input section and including an interiorly splined end region adapted for being coupled to a splined end region of an input shaft for being driven in rotation about an input axis,
an input gear being coupled to said input collar for being driven about said input axis;
an input gear bearing assembly mounting said input gear for rotation about said input axis and including first and second thrust bearings;
an output shaft mounted in said housing for rotation about an output axis located at a height which is below said input axis;
a second gear being mounted in said housing for rotation about said output axis and being coupled for driving said output shaft, and said second gear being meshed for being driven by said input gear;
fixed walls within said housing surfaces defining a compartment containing said input and second gears, and said compartment being adapted for containing lubrication oil to a level above at least a lower region of said second gear, whereby said second gear will dip into said oil during rotation and act together with said input gear to sling oil upwardly within said compartment onto compartment surface locations located above said input gear bearing assembly; and
a first lubrication oil passage extending from one end to another of said input gear and having an inlet end located adjacent a compartment wall region adjacent an end of said input gear, and having an outlet located in fluid communication with said splined end region of said connection collar; and
a bypass lubrication oil passage having an inlet located for receiving slung oil from said compartment surface locations and having an outlet located in fluid communication with said inlet end of said first lubrication oil passage, whereby said bypass and first lubrication oil passages route slung oil to said splined end region of said connection collar.

5. The final drive transmission, as defined in claim 4, wherein said lubrication oil passage is located along said input rotation axis.

6. The final drive transmission, as defined in claim 4, wherein said input gear includes a splined extension at one end which is coupled to said input connection collar.

7. The final drive transmission, as defined in claim 5, wherein a tube projects axially within the inlet end of the oil passage and is joined to a sheet metal cup received in a recess in the housing surrounding the tube.

8. The final drive transmission, as defined in claim 5, wherein a blind bore is located in the housing in axial alignment with the input rotation axis;
said blind bore being joined to a shallow annular recess provided in said housing of said roller bearing;
a cup being received in said shallow annular recess;
a lubrication tube located along said axis, extending through, and fixed to said cup and having opposite ends respectively received in sad first lubrication oil passage and said blind bore;
and said bypass lubrication oil passage having an outlet end joined to said blind bore.
